(19) United States
(12) Patent Application Publication
(10) Pub. No.: US 2017/0157516 A1
(43) Pub. Date: Jun. 8, 2017

(54) SYSTEM AND METHOD FOR MANAGING WORD GAMES

(71) Applicant: Mark Rudes, Boca Raton, FL (US)

(72) Inventor: Mark Rudes, Boca Raton, FL (US)

(21) Appl. No.: 15/356,572

(22) Filed: Nov. 19, 2016

(51) Int. Cl. A63F 13/69; A63F 13/92; A63F 13/352; A63F 13/46; A63F 13/85; A63F 13/48; A63F 13/822; A63F 13/79

(52) U.S. Cl. CPC A63F 13/69; A63F 13/822; A63F 13/92; A63F 13/79; A63F 13/46; A63F 13/85; A63F 13/48; A63F 13/352; A63F 2300/807; A63F 2300/408

(57) ABSTRACT

The embodiments herein provide a system and method for managing word games. The computing devices of the players host a software application that presents a grid layout with squares for playing the word game. The player invites other set of players and initiates a new game. At the start of the game the bonus squares are randomized. Each player is assigned with same inventory of alphabets. Each player places the alphabets on the squares to form the words. During the game, the player uses strategic tools to score more points or block opponents. Every move by a player is communicated to other players of the game by updating the alphabet placements on the board game. At the end of the word game, the score is calculated for each player based on score points of the alphabets used by the player in forming all the words and a rank is assigned.

### BACKGROUND

Technical Field

The embodiments herein are generally related to the field of interactive games. The embodiments herein are particularly related to computer-implemented games. The embodiments herein are more particularly related to improvements to a system and method of playing a word game.

Description of the Related Art

Traditionally games are played in real-time at the location of the game with other participants. Some games are classified as board games which are typically provided a game layout that is well defined or formed by a set of demarcations on a board. Typically, the players are made to advance in the game by moving the related pieces such as tokens, tiles or markers along the various paths on the game layout to win the game.

One of the commonly played and famous board game is a word game which includes word formations ranging from simple to complex words. Generally, the word game involves two to four players playing at a time. Playing of word game requires a physical board with a grid layout and the tiles having alphabets embedded on them. Typically, the player scores points in a word games based on various parameters such as usage of uncommon alphabets, length of word formed and the like. To make the game more interesting, the word games also offers specific designated areas/squares which are used by the players for scoring additional points also known as bonus squares. Similarly some tiles are also provided with special functionality such as blank tiles which are used for representing any alphabet.

Typically, the word game requires the players to draw out a set of alphabets from a pool of alphabets and form a word as part of his/her turn. The score calculation of the game depends upon the usage of alphabets and the corresponding score points related to each alphabet. The score points for the uncommon alphabets such as Z, U and the like, is higher as compared to the commonly used alphabets such as B, D etc. Thus the player always wishes to get such letters to score more points. On the other hand, the number of tiles in the pool for uncommon alphabets is less than the number of tiles in the pool for common alphabets. Hence the game also depends upon the luck of the player for drawing the alphabets with higher score points. As the game depends upon luck factor, the game does not offer an equal playground for all the players to score in the game.

The game involves a very little or substantive player interaction and the requirement of using the static physical board is somewhat limiting the place and method of play. Although the word game has the blank game tile, the game does not have any game pieces that change the method or sequence of play. Each player plays in his turn only. When one of the players has used all their allocated letter tiles in correct words, the game ends. A player scored with the highest point among all the players, wins the game. The score of each player is calculated based on the total score of used letter tiles. Thus, the players only have an option of scoring by using letter tiles in word formations. As a result, the play of the game is somewhat slow and monotonous resulting in loss of interests among the players. Further, conducting a global tournaments for the word games becomes difficult as this requires players to travel across countries and physically present at a common location thereby incurring a lot of expenses. Thus, the participation rate for such tournaments is very limited.

Hence, there is a need for a system and method for creating, conducting and managing a more dynamic and interesting the word game by offering a plurality of mutually different game boards for every new game. Further, there is a need for a system and method for playing the word game without requiring the physically co-located players. Still further, there is a need for a system and method for playing the word game that offers equal scoring opportunity for all the players and does not depend on any luck factor. Yet there is a need for an improved word game that offers the merits of conventional games while adding new features that enrich the game-playing experience, provide practical conveniences, offers new ways to make gaming fresher and more exciting for the players.

The above mentioned shortcomings, disadvantages and problems are addressed herein and which will be understood by reading and studying the following specification.

### OBJECTS OF THE EMBODIMENTS

The primary object of the embodiments herein is to provide a system and method for managing word games.

Another object of the embodiments herein is to provide a system and method a game to enable a player to participate in a plurality of word games at a time.

Yet another object of the embodiments herein is to provide a system and method for developing a dynamic and interesting word game by offering a different/new/fresh game board for every new game.

Yet another object of the embodiments herein is to provide a system and method for presenting a game board with varying a placement of bonus squares every time the player plays/starts a new game.

Yet another object of the embodiments herein is to provide a system and method for developing a word game for allowing the players to participate with or without physically present/co-located at a game area.

Yet another object of the embodiments herein is to provide a software application for the computing devices for facilitating easy access to the word game for the players.

Yet another object of the embodiments herein is to provide a system and method for developing a word game to present/provide the players with one or more bonus squares with special functionalities.

Yet another object of the embodiments herein is to provide a system and method for developing a word game for presenting the players with a plurality of strategic tools which are used during the play to help the players to earn additional points and to strategize their play.

Yet another object of the embodiments herein is to provide a system and method for developing a word game for assigning a rank and credit points for each player at the end of each game based on the performance of each player.

Yet another object of the embodiments herein is to provide a system and method for developing a word game for conducting tournaments thereby allowing a participation of plurality of players for different levels of the of the word game.

Yet another object of the embodiments herein is to provide a system and method for developing a word game for providing the players with information related to reminders of various word games, features, changes and upcoming events.

Yet another object of the embodiments herein is to provide a system and method for developing a word game for offering the player with an easy access to several methods of inviting others to play a game.

Yet another object of the embodiments herein is to provide a system and method for developing a word game for connecting the players through social networking sites to offer collaborative/competitive multi-player virtual board game experience.

Yet another objective of the embodiment herein is to provide a system and method for developing a word game that offers the player an option to play the word game with other players using a single computing device.

Yet another objective of the embodiment herein is to provide a system and method for developing a word game for offering a same set of alphabets in both count and value to the players and for deciding the outcome of the word game based on utility of these alphabets by a player.

Yet another objective of the embodiment herein is to provide a system and method for developing a word game that offers an equal scoring opportunity for all the players.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a word game management system. The system comprises a computing device of a player configured for hosting a software application to interact with a server provided in the system. The software application is configured for presenting a grid layout to the player for playing the word game. The grid layout comprises plurality of squares for placing one or more alphabets to form a word. The grid layout further comprises one or more bonus squares for offering additional features. A registration module is provided in the server. The registration module is run on a hardware processor and is configured for registering plurality of players with the system by providing one or more personal details. An initialization module provided in a server is run on a hardware processor and is configured for initializing the word game on the computing devices of the plurality of registered players. The initialization module is configured for assigning each player with an inventory of same set of alphabets and randomly placing one or more bonus squares on the grid layout at the start of each new word game. Each alphabet in the inventory is assigned with a predefined score point which is a fixed value for that alphabet. An interaction module provided in a server is run on a hardware processor and is configured for connecting a plurality of remotely located computing devices of players participating in the word game with the server. The interaction module is configured to communicate every move made by each player to other players participating in the same word game. A score calculation module provided in a server is run on a hardware processor and is configured for calculating a score for each player at the end of each word game on exhaustion of inventory of alphabets associated with any player. The score for each player is calculated based on the total score (points) of the alphabets used by the player for forming all the words and the used bonus square while playing the word game. A ranking module provided in a server, is run on a hardware processor and is configured for determining a rank of each player in comparison with other players at the end of each word game based on the current and historical score.

According to an embodiment herein, the initialization module is further configured for creating a credit account for each player registered with the system for maintaining credit points associated with each player. Each player is assigned with a predefined number of credit points on registering with the system.

According to an embodiment herein, the system further comprises a database configured for storing an individual score associated with each player for each word game. The database is further configured for storing a historical score associated with each player for previously played word games and credit account details associated with each player.

According to an embodiment herein, the system is further configured for providing each player with one or more strategic tools for use during each word game on deduction of predefined number of credit points. The one or more strategic tools are configured for helping the player to strategize the play against the opponent or for increasing the chances of winning the word game by increasing the player's game score.

According to an embodiment herein, the one or more strategic tools comprise a boost tool for increasing the value of a bonus square by a predefined factor, a blank tool for providing the player with a blank tile which is used for a replacement of any alphabet to form a word, a scramble tool that scrambles any unused bonus squares for a turn of the player and then returns back to the original position assigned at the start of the game, a blocking square tool that allows the player to place a blocking square on the game board to block the opponent from accessing their alphabets, a letter tracker tool that allows a player to view inventory of alphabets for all the players within the game themselves and the opponents and the like.

According to an embodiment herein, the system further comprises a credit estimation module configured for assigning or deducting credit points to/from each players credit account based on one or more criteria. The one or more criteria for assigning or deducting the credit points comprise winning/losing a word game, selecting a new game for playing, winning different levels of a tournament, use of one or more strategic tools during the play, paid purchases of the credit points and the like.

According to an embodiment herein, the system further comprises a notification module configured for generating one or more notifications for notifying the players regarding the proceedings of the word game.

According to an embodiment herein, the one or more notifications generated using the notification module comprise notifications regarding a status of the word game, a pending turn of the opponents, an own turn of the players, and the like.

According to an embodiment herein, the additional features provided by bonus squares comprise one or more double and triple letter squares leading to an addition of double and triple scores/points for the alphabet placed on the square to the players score respectively, one or more double and triple word square leading to an addition of double and triple scores/points for the whole word formed to the players score respectively, one or more ‘Go’ square that provides the player with an additional turn and one or more blocking square where none of the alphabet is placed during the play or to block a placement of the alphabets by an opponent player.

According to an embodiment herein, the plurality of players are provided with a predefined number of chances before losing their turn to form a word.

According to an embodiment herein, the initialization module is further configured for randomly filling the already used alphabets for each player in their turn to maintain a predefined number of consonants and vowels for forming each word.

According to an embodiment herein, the software application is further configured for timely updating the plurality of players regarding future events and tournaments open for participation.

According to an embodiment herein, the system is further configured for providing the plurality of players with an option to play the word game on a single computing device by being physically present at a same location as that of the computing device.

According to an embodiment herein, the system is further configured for providing each player with an option to play one or more word games simultaneously with remotely located players via/through the computing device.

According to an embodiment herein, a method is provided for managing word games. The method comprises the steps of registering a plurality of players with the system via a computing device of the player by providing one or more personal details. The computing device of the player is configured for downloading and hosting a software application to interact with a server provided in the system. The software application is configured for presenting a grid layout to the player for playing the word game. The grid layout comprises plurality of squares for placing one or more alphabets to form a word. The grid layout further comprises one or more bonus squares for offering additional features. The word game with a random placement of bonus squares is initialized at the start of each new word game on the computing devices of the plurality of registered players through an initializing module. The initialization module is configured for assigning each player with an inventory of same set of alphabets. The plurality of remotely located computing devices of players participating in the word game are connected with the server through an interaction module. The interaction module is configured to communicate each and every move/movement made by each player to other players (rest of the players) participating in the same word game. A score/point for each player is calculated at the end of each word game on exhaustion of inventory of alphabets associated with any player through a score calculation module. The score for each player is calculated based on the total score/points of the alphabets used by the player for forming all the words while playing the word game and used bonus squares. A rank of each player is determined in comparison with other players at the end of each word game based on the current and historical score through a ranking module.

According to an embodiment herein, a plurality of credit points are assigned or deducted for each player based on one or more criteria through a credit calculation module. The one or more criteria for assigning or deducting the credit points comprise winning/losing a word game, selecting a new game for playing, winning different levels of a tournament, use of one or more strategic tools during the play, purchased credit points and the like.

According to an embodiment herein, the method further comprises providing each player with one or more strategic tools for use during each word game on deduction of a predefined number of credit points. The one or more strategic tools are configured for helping the player to strategize the play against the opponent player or rest of the participating players or for increasing the chance of winning the game by increasing the player score.

According to an embodiment herein, the additional features provided by bonus squares comprise one or more double and triple letter square for adding double and triple scores/points for the alphabet placed on the square to the players score respectively, one or more double and triple word square for adding double and triple scores/points for the whole word formed to the players score respectively, one or more ‘Go’ square that provides the player with an additional turn and one or more blocking squares for blocking other or rest of the players or opponent player from placing an during the course of play or during a progress of a play.

The others denotes other opponent players or the rest of the players participating in a word game.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of the word game management system, according to one embodiment herein.

FIG. 2 illustrates a screen shot or a schematic representation of the software application screen for providing multiple options for logging into the system, according to one embodiment herein.

FIG. 3 illustrates a screen shot or a schematic representation of the software application screen for providing an option of logging into the system using email ID, according to one embodiment herein.

FIG. 4 illustrates a screen shot or a schematic representation of the software application screen for exhibiting the main menu used by the player to access various features of the word game, according to one embodiment herein.

FIG. 5 illustrates a screen shot or a schematic representation of the software application screen for displaying multiple choices of choosing an opponent for starting the word game, according to one embodiment herein.

FIG. 6 illustrates a screen shot or a schematic representation of the software application screen for configuring personal settings of the players, according to one embodiment herein.

FIG. 7 illustrates a screen shot or a schematic representation of the software application screen for providing a game board used for playing the word game, according to one embodiment herein.

FIG. 8 illustrates a screen shot or a schematic representation of the software application screen used by the player for placing alphabets for forming a word during the play, according to one embodiment herein.

FIG. 9 illustrates a screen shot or a schematic representation of the software application screen for providing one or more strategic tools to the player for playing the word game, according to one embodiment herein.

FIG. 10 illustrates a screen shot or a schematic representation of the software application screen for providing the strategic tool letter tracker, according to one embodiment herein.

FIG. 11 illustrates a screen shot or a schematic representation of the software application screen for displaying a home page of the software application, according to one embodiment herein.

FIG. 12 illustrates a screen shot or a schematic representation of the software application screen for indicating/notifying a ranking of the player against other set of players, according to one embodiment herein

FIG. 13 illustrates a screen shot or a schematic representation of the software application screen for providing a historical data related to the word games previously played by the player, according to one embodiment herein.

FIG. 14 illustrates a screen shot or a schematic representation of the software application screen for providing a feedback form to be filled in by the player to provide feedback about the game, according to one embodiment herein.

FIG. 15 illustrates a flow chart explaining a method for managing word games, according to one embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a word game management system. The system comprises a computing device of a player configured for hosting a software application to interact with a server provided in the system. The software application is configured for presenting a grid layout to the player for playing the word game. The grid layout comprises plurality of squares for placing one or more alphabets to form a word. The grid layout further comprises one or more bonus squares for offering additional features. A registration module is provided in the server. The registration module is run on a hardware processor and is configured for registering plurality of players with the system by providing one or more personal details. An initialization module provided in a server is run on a hardware processor and is configured for initializing the word game on the computing devices of the plurality of registered players. The initialization module is configured for assigning each player with an inventory of same set of alphabets and randomly placing one or more bonus squares on the grid layout at the start of each new word game. Each alphabet in the inventory is assigned with a predefined score point which is a fixed value for that alphabet. An interaction module provided in a server is run on a hardware processor and is configured for connecting a plurality of remotely located computing devices of players participating in the word game with the server. The interaction module is configured to communicate every move made by each player to other players participating in the same word game. A score calculation module provided in a server is run on a hardware processor and is configured for calculating a score for each player at the end of each word game on exhaustion of inventory of alphabets associated with any player. The score for each player is calculated based on the total score (points) of the alphabets used by the player for forming all the words and the used bonus square while playing the word game. A ranking module provided in a server, is run on a hardware processor and is configured for determining a rank of each player in comparison with other players at the end of each word game based on the current and historical score.

According to an embodiment herein, the initialization module is further configured for creating a credit account for each player registered with the system for maintaining credit points associated with each player. Each player is assigned with a predefined number of credit points on registering with the system.

According to an embodiment herein, the system further comprises a database configured for storing an individual score associated with each player for each word game. The database is further configured for storing a historical score associated with each player for previously played word games and credit account details associated with each player.

According to an embodiment herein, the system is further configured for providing each player with one or more strategic tools for use during each word game on deduction of predefined number of credit points. The one or more strategic tools are configured for helping the player to strategize the play against the opponent or for increasing the chances of winning the word game by increasing the player's game score.

According to an embodiment herein, the one or more strategic tools comprise a boost tool for increasing the value of a bonus square by a predefined factor, a blank tool for providing the player with a blank tile which is used for a replacement of any alphabet to form a word, a scramble tool that scrambles any unused bonus squares for a turn of the player and then returns back to the original position assigned at the start of the game, a blocking square tool that allows the player to place a blocking square on the game board to block the opponent from accessing their alphabets, a letter tracker tool that allows a player to view inventory of alphabets for all the players within the game themselves and the opponents and the like.

According to an embodiment herein, the system further comprises a credit estimation module configured for assigning or deducting credit points to/from each players credit account based on one or more criteria. The one or more criteria for assigning or deducting the credit points comprise winning/losing a word game, selecting a new game for playing, winning different levels of a tournament, use of one or more strategic tools during the play, paid purchases of the credit points and the like.

According to an embodiment herein, the system further comprises a notification module configured for generating one or more notifications for notifying the players regarding the proceedings of the word game.

According to an embodiment herein, the one or more notifications generated using the notification module comprise notifications regarding a status of the word game, a pending turn of the opponents, an own turn of the players, and the like.

According to an embodiment herein, the additional features provided by bonus squares comprise one or more double and triple letter squares leading to an addition of double and triple scores/points for the alphabet placed on the square to the players score respectively, one or more double and triple word square leading to an addition of double and triple scores/points for the whole word formed to the players score respectively, one or more ‘Go’ square that provides the player with an additional turn and one or more blocking square where none of the alphabet is placed during the play or to block a placement of the alphabets by an opponent player.

According to an embodiment herein, the plurality of players are provided with a predefined number of chances before losing their turn to form a word.

According to an embodiment herein, the initialization module is further configured for randomly filling the already used alphabets for each player in their turn to maintain a predefined number of consonants and vowels for forming each word.

According to an embodiment herein, the software application is further configured for timely updating the plurality of players regarding future events and tournaments open for participation.

According to an embodiment herein, the system is further configured for providing the plurality of players with an option to play the word game on a single computing device by being physically present at a same location as that of the computing device.

According to an embodiment herein, the system is further configured for providing each player with an option to play one or more word games simultaneously with remotely located players via/through the computing device.

According to an embodiment herein, a method is provided for managing word games. The method comprises the steps of registering a plurality of players with the system via a computing device of the player by providing one or more personal details. The computing device of the player is configured for downloading and hosting a software application to interact with a server provided in the system. The software application is configured for presenting a grid layout to the player for playing the word game. The grid layout comprises plurality of squares for placing one or more alphabets to form a word. The grid layout further comprises one or more bonus squares for offering additional features. The word game with a random placement of bonus squares is initialized at the start of each new word game on the computing devices of the plurality of registered players through an initializing module. The initialization module is configured for assigning each player with an inventory of same set of alphabets. The plurality of remotely located computing devices of players participating in the word game are connected with the server through an interaction module. The interaction module is configured to communicate each and every move/movement made by each player to other players (rest of the players) participating in the same word game. A score/point for each player is calculated at the end of each word game on exhaustion of inventory of alphabets associated with any player through a score calculation module. The score for each player is calculated based on the total score/points of the alphabets used by the player for forming all the words while playing the word game and used bonus squares. A rank of each player is determined in comparison with other players at the end of each word game based on the current and historical score through a ranking module.

According to an embodiment herein, a plurality of credit points are assigned or deducted for each player based on one or more criteria through a credit calculation module. The one or more criteria for assigning or deducting the credit points comprise winning/losing a word game, selecting a new game for playing, winning different levels of a tournament, use of one or more strategic tools during the play, purchased credit points and the like.

According to an embodiment herein, the method further comprises providing each player with one or more strategic tools for use during each word game on deduction of a predefined number of credit points. The one or more strategic tools are configured for helping the player to strategize the play against the opponent player or rest of the participating players or for increasing the chance of winning the game by increasing the player score.

According to an embodiment herein, the additional features provided by bonus squares comprise one or more double and triple letter square for adding double and triple scores/points for the alphabet placed on the square to the players score respectively, one or more double and triple word square for adding double and triple scores/points for the whole word formed to the players score respectively, one or more ‘Go’ square that provides the player with an additional turn and one or more blocking squares for blocking other or rest of the players or opponent player from placing an during the course of play or during a progress of a play.

The others denotes other opponent players or the rest of the players participating in a word game.

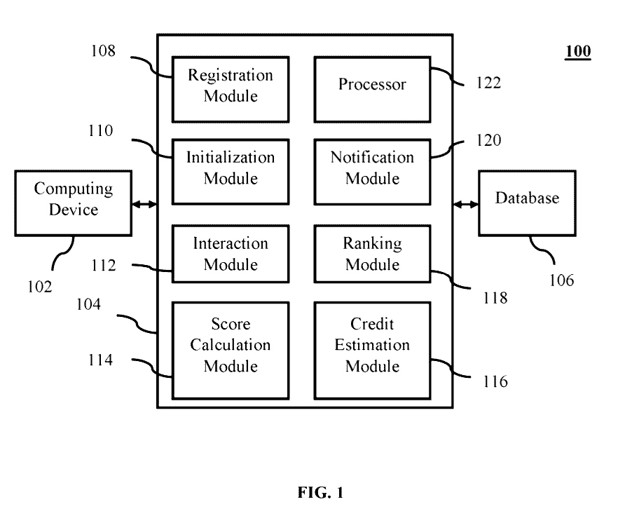

FIG. 1 illustrates a functional block diagram of the system for managing word games, according to one embodiment herein. The system comprises a computing device 102, a server 104 and a database 106. The server 104 comprises a registration module 108, an initialization module 110, an interaction module 112, a score calculation module 114, a credit estimation module 116, a ranking module 118, a notification module 120 and a processor 122.

According to an embodiment herein, the computing device 102 of a player is configured for hosting a software application to interact with the server 104 provided in the system 100. The software application is configured for presenting a grid layout to the player for playing the word game. The grid layout comprises plurality of squares for placing one or more alphabets to form a word. The grid layout further comprises one or more bonus squares offering additional features. The computing device 102 comprises a personal computer, mobile phone, laptop, PDA, or combinations thereof. The software application is further configured for timely updating the plurality of players about future events and tournaments open for participation.

According to an embodiment herein, the additional features provided by bonus squares comprise one or more double and triple letter square leading to addition of double and triple score point for the alphabet placed on the square to the players score respectively, one or more double and triple word square leading to addition of double and triple score point for the whole word formed to the players score respectively, one or more ‘Go’ square that provides the player additional turn and one or more blocking square where none of the alphabet is placed during the play.

According to an embodiment herein, the server 104 comprises a processor 122 configured for processing requests received from other modules and interacts with the database 106. The registration module 108 is configured for registering plurality of players with the system 100 by providing one or more personal details. The personal details provided by the players comprise name, email ID, phone number and the like.

According to an embodiment herein, the initialization module 110 is configured for initializing the word game on the computing devices 102 of the plurality of registered players. The initialization module 110 is configured for assigning each player with an inventory of same set of alphabets and randomly placing one or more bonus squares on the grid layout at the start of each new word game. Each alphabet in the inventory is assigned a predefined fixed score point. The initialization module 110 is further configured for creating a credit account for each player registered with the system 100 for maintaining credit points associated with each player. Each player is assigned with a predefined number of credit points on registering with the system 100. The initialization module 110 is further configured for randomly filling in the used alphabets from the inventory for each player's turn in order to maintain a predefined number of consonants and vowels for forming each word. Fixed number of consonants and vowels are maintained so that the player does not have to deal with the problem of forming the word with only consonants or vowels. The word game always starts with the turn of the player that initiates a new word game request. The player starts the game by placing the alphabet at the designated starting location marked on the game board.

According to an embodiment herein, the interaction module 112 is configured for connecting the remotely located plurality of computing devices 102 of players participating in the word game with the server 104. The interaction module 112 communicates every move made by each player to other players participating in the same word game. Each player is provided with a predefined number of chances before losing their turn to form a word. The system additionally provides a feature to the players to skip their turn and replace all the selected alphabets with a new set of alphabets from the inventory. The replacement alphabets are randomly assigned by the system 100.

According to an embodiment herein, the score calculation module 114 is configured for calculating score for each player at the end of each word game on exhaustion of inventory of alphabets associated with any player. The word game completes when one player uses their last consonant or when a player chooses an option to skip the chance for forming a word twice in a row. The score for each player is calculated based on score points of the alphabets used by the player for forming all the words while playing the word game. All the vowels have a fixed score point while the score points for the consonants vary depending on frequency of usage. There is a fixed time duration provided to the players to make a move. On expiration of this time duration the word game is terminated and the score for this word game is not counted into the player's average game score.

According to an embodiment herein, the database 106 is configured for storing individual score associated with each player for each word game. The database 106 is further configured for storing historical score associated with each player for previously played word games and credit account details associated with each player.

According to an embodiment herein, the system 100 is further configured for providing each player with one or more strategic tools for use during each word game on deduction of predefined number of credit points. The one or more strategic tools are configured for helping the player to strategize the play against the opponent or for increasing the chance of winning the game by increasing the player score. The one or more strategic tools comprise a boost tool for increasing the value of a bonus square by a predefined factor, a blank tool which provides the player with a blank tile which is used as a replacement of any alphabet to form a word, a scramble tool that scrambles any unused bonus squares for a turn of the player and then returns back to the original position assigned at the start of the game, a blocking square tool that allows the player to place a blocking square on the game board in order to block the opponent from accessing their alphabets, a letter tracker tool that allows a player to view inventory of alphabets for all the players of the game and the like. Some of these strategic tools are allowed to be used only once while others are allowed to be used multiple times during a word game.

According to an embodiment herein, the system further comprises a credit estimation module 116 configured for assigning or deducting credit points to/from each players credit account based on one or more criteria. The one or more criteria for assigning or deducting the credit points comprise winning/losing a word game, selecting a new game for playing, winning different levels of a tournament, use of one or more strategic tools during the play, paid purchases of the credit points and the like.

According to an embodiment herein, the ranking module 118 is configured for determining the rank of each player in comparison with other players at the end of each word game based on the current and historical score. The ranking module 118 determines the rank by taking an average of the historical score associated with each player for last few word games. Multiple rankings are assigned to the players based on different criteria such as by comparing score against a group of friends, group of players worldwide and the like.

According to an embodiment herein, the system further comprises a notification module 120 configured for generating one or more notifications for notifying the players about the proceedings of the word game. The one or more notifications generated using the notification module 120 comprise notifications about status of the word game, opponents pending turn, players own turn and the like.

According to an embodiment herein, the player initiating a new game has plurality of options to choose the opponents. The options include inviting the social networking friends to play the game, choosing the random opponent available and connected to the system, inviting a specific registered player via username or email address and the like.

According to an embodiment herein, the system 100 is configured for providing each player with an option to play one or more word games simultaneously with remotely located players via the computing device 102.

According to an embodiment herein, the system 100 is further configured for providing the plurality of players with an option to play the word game on a single computing device 102 by being physically present at a same location as that of the computing device 102. For this type of games, the players are not allowed to use any strategic tools. When the game is played with this option the credits points are not assigned or deducted to/from the player's credit account. Further, the ranks are not determined for the players based on the outcome of these word games.

According to an embodiment herein, the system 100 is further configured to allow a player to have up to 40 games open at one time.

According to an embodiment herein, the system 100 is further configured to allow a player to get six consecutive tries to spell a word correctly before losing their turn. This is provided as six turns one after the other or a player is allowed to leave the game and come back to it later. However, the game remembers how many tries a player has already used and the total of six tries before losing a turn still is in effect.

According to an embodiment herein, the primary feature, that makes the word game of the embodiments herein unique among other word games, is the fact that each player across the word wide always starts with the exact same supply of letters in both count and value. The game is decided by how well a player uses their letters and not by the luck of drawing the higher value letters. Skill not luck is used to win the game.

According to an embodiment herein, the system 100 is further configured to make a single blank letter available only as one of the Tools of The Trade. There is no blank included in a player's basic inventory.

According to an embodiment herein, the system 100 is further configured to provide a 30-day time limit a player has to make a move. When no move is made by a player during the 30-day period, the game ends but is not counted into a player's average game score.

According to an embodiment herein, the system 100 is further configured to allow all players to begin with the exact same consonants in their own supply but they are randomly fed into each player's hand.

According to an embodiment herein, the numeric value of each players remaining inventory is deducted from a player's total score at the end of the game. Games end when one player uses their last consonant or when a player passes twice in a row.

According to an embodiment herein, there is currently no tournament feature in the game. There are only two players in each game.

According to an embodiment herein, the system 100 is further configured to allow a player to choose to skip their turn and replace selected letters in their hand. The replacement letters are randomly selected by the game and not chosen by the player.

According to an embodiment herein, all the vowels have a value of 1 point and come out of a shared supply. Both consonants and vowels are randomly fed into a player's hand. 4 consonants out of a players own letter supply and three vowels out of the shared supply of vowels are available to a player until they are used up. When a player used 2 vowels in making a word, the game automatically and randomly refills their vowel supply from the shared vowel supply to bring it back to 3 vowels.

According to an embodiment herein, the system 100 is further configured prior to placing his or her word on the board, to allow a player to place a blocking square in an effort to block their opponent from accessing a specific spot on the board. Blocking squares are not be placed on the bonus squares.

According to an embodiment herein, the system 100 is further configured to provide 11 different drop down menus or displays boards. They are as follows: (1) The menu—APP STORE REVIEW is provided to allow more players to play the game better, thereby enabling leave a good review in the App Store Thank you. (2) The menu—“WELCOME TO EVEN STEVEN/word game” is displayed to invite the players to the World's Most Advanced Word Game (3) The menu—TOOLS OF THE TRADE are displayed for providing more tools for use to Earn Higher Scores. (4) The menu—“THE GAME BOARD IS ACTIVE” is displayed to ramble all bonus squares before the start of a new game. (5) The menu—“STRATEGY HAS REPLACED LUCK” is displayed to allow all players to start each game with the exact same letters. (6) The menu—YOU GET 6 TRIES TO SPELL A WORD CORRECTLY—is displayed to enable a player to choose carefully or lose your turn. (7) The menu—INVITE YOUR FRIENDS TO PLAY is displayed to invite your friends to participate in the game using Text, Email, or Facebook (8) The menu—CONTACT US is provided for allowing players to provide or register any complaint or suggestion through email from the Home Page. (9) The menu—RANKING—is provided to indicate your ranking in the game. 20 most recent games of a player are averaged together to give an average score. (10) The menu—VOWELS and CONSONANTS—is displayed to provide each Hand with Four Consonants and Three Vowels. (11) The menu—RANDOM PLAY—is displayed to invite Random Players to the game.

According to an embodiment herein, the system 100 is further configured to allow a player to have up to 40 games open at one time.

According to an embodiment herein, the essential features of the game are as follows. There are two new bonus squares: all bonus squares are randomly scrambled before each new game. All players start with the exact same letters in value and count. All hands contain 4 consonants and 3 vowels, no hands with all vowels or all consonants like in other games. Only 6 tries are provided to spell a word correctly. Five tools of the trade are provided to add a level of strategy

According to an embodiment herein, the additional features that are added to the game are as follows: Tournament Play is provided to allow players of equal ranking to play each other to determine the best player in their division. Different languages are added to attract different users.

According to an embodiment herein, the advantages of word game of the system over existing word games are as follows: The luck inherent to other words games has been completely removed. This word game of the embodiments herein is a game of skill. The all bonus squares are scrambled before each new game. Tools of the trade and six tries are provided to place/add a correct word to make the word game of the embodiments herein more interesting and skill based.

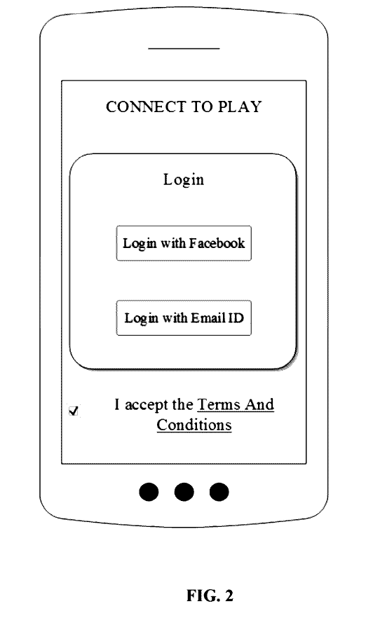

FIG. 2 illustrates a screen shot of the software application screen for providing multiple options for registering with the system, according to one embodiment herein. With respect to FIG. 2, the player is permitted to login into the system using various social networking accounts (e.g. Facebook account) or by using the personal email ID of the player. The registration of the player is permitted only when the player accepts the terms and condition of the game.

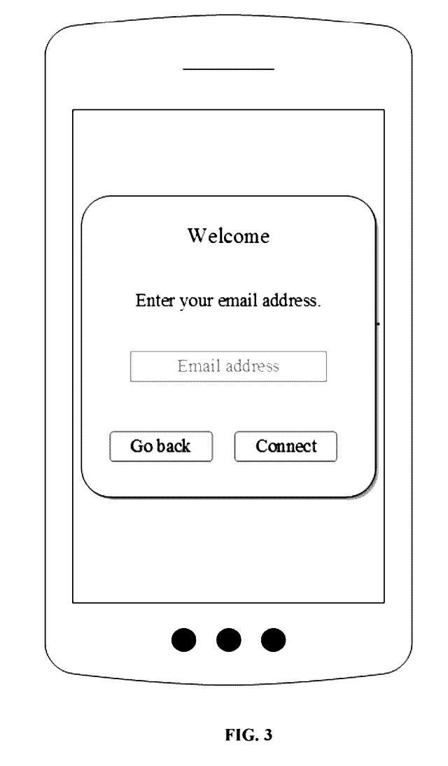

FIG. 3 illustrates a screen shot of the software application screen providing an option for logging into the system using email ID, according to one embodiment herein. With respect to FIG. 3, on choosing the option of logging in using personal email ID, the player needs to enter the email ID in the designated cell provided in the screen.

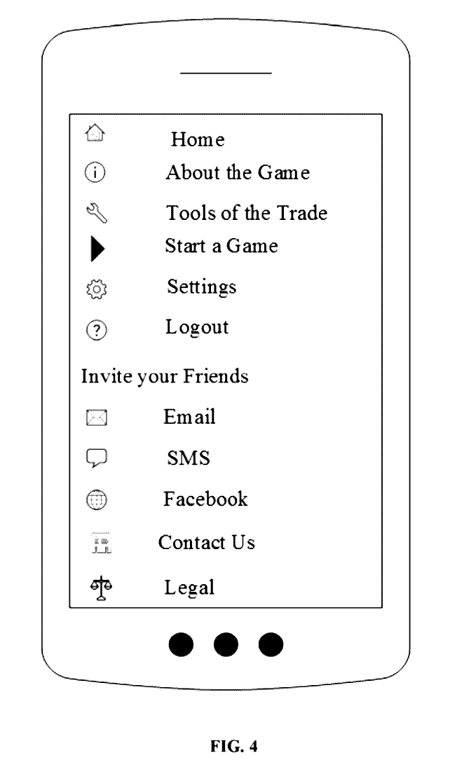

FIG. 4 illustrates a screen shot of the software application screen displaying the main menu used by the player to access various features of the word game, according to one embodiment herein. With respect to FIG. 4, after completing the login process, the player is provided with a main menu associated with the software application. The main menu provided several options to the player such as information about the word game, list of strategic tools available while playing the game, start a new game, settings, logging out of the software game, inviting friends for playing the game by sending email, social networking request or through SMS.

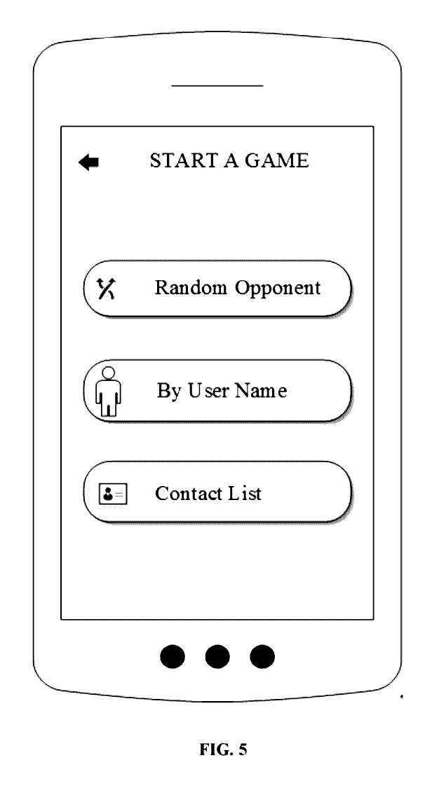

FIG. 5 illustrates a screen shot of the software application screen displaying multiple choices of choosing an opponent for starting the word game, according to one embodiment herein. With respect to FIG. 5, the player is provided with an option to choose an opponent to play the word game by randomly selecting any logged in player, by sending invite providing user details such as name or by selecting the player from the contact list of the computing device. Once a player chooses an option to play with a random opponent, the system sends the playing request to any of the registered player chosen randomly and notifies back the player upon acceptance of the request by the opponent.

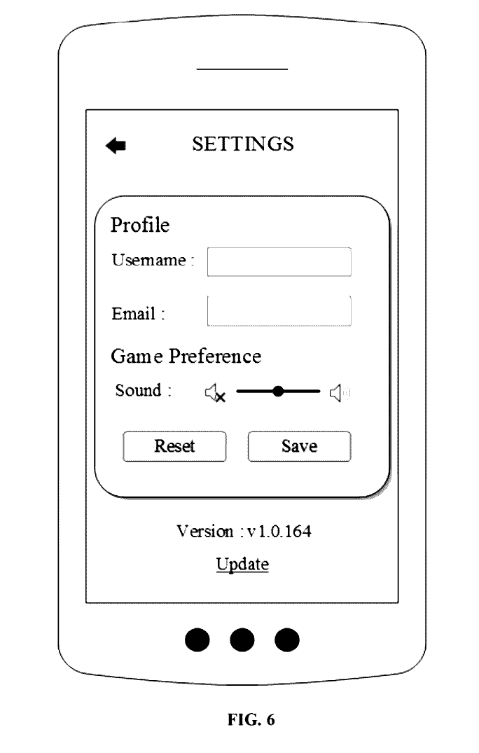

FIG. 6 illustrates a screen shot of the software application screen for configuring personal settings of the players, according to one embodiment herein. With respect to FIG. 6, the system provides the player an option to configure personal settings such as username, email ID etc. The player is further allowed to configure the sound settings for the word game. The system additionally displays the current version running on the computing device of the player and provides the player an option to download the latest version of the software application from the system.

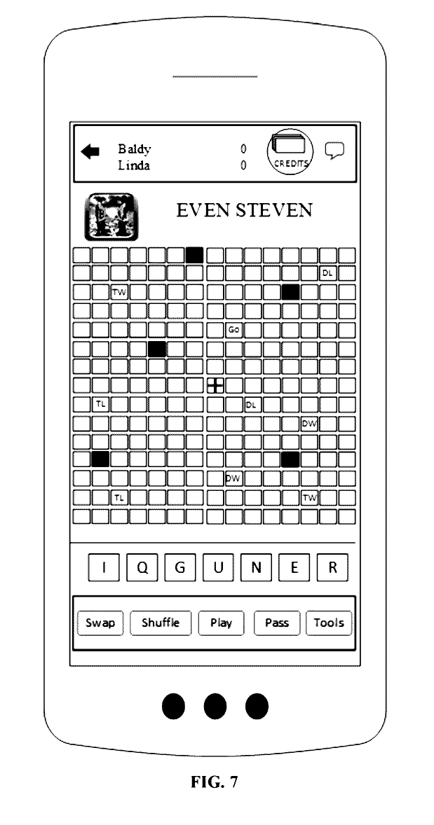

FIG. 7 illustrates a screen shot of the software application screen displaying a game board used for playing the word game, according to one embodiment herein. With respect to FIG. 7, the game board as presented on the computing device of the player comprises a grid layout of squares. The grid layout also comprises several bonus squares placed at random locations on the game board. The designated starting location is marked on the game board. The list of alphabets available for forming the word are displayed at the bottom of the screen. A tool bar is provided to the player with options for swapping or shuffling the alphabets, resuming the play, passing the turn to the next player and invoking strategic tools. The player is allowed to place the alphabets on to the squares within the grid in interactive manner for example by tapping the square followed by the taping of alphabets or by dragging and dropping the alphabet on to the square and the like

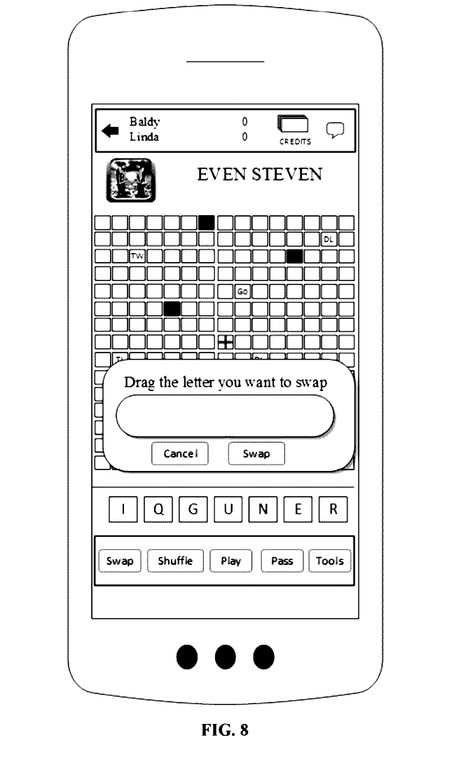

FIG. 8 illustrates a screen shot of the software application screen used by the player for swapping the alphabets during the play, according to one embodiment herein. With respect to FIG. 8, on selecting a swap option from the tool bar a swapping window is presented to the player. The player is allowed to drag the alphabets to the swapping window for marking that alphabet for swapping. The swapped alphabets are replaced with new set of alphabets to form the word.

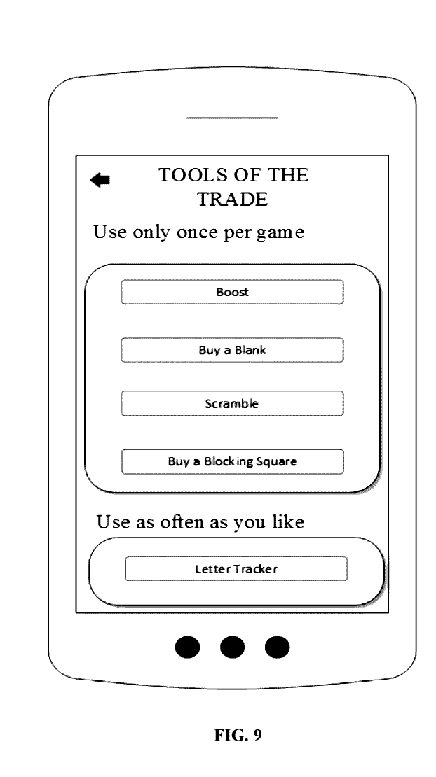

FIG. 9 illustrates a screen shot of the software application screen for providing one or more strategic tools available to the player for playing the word game, according to one embodiment herein. With respect to FIG. 9, on selecting a strategic tool option from the tool bar various strategic tools available for use during the play are displayed to the player. The list of strategic tools includes a boost tool for increasing the value of a bonus square by a predefined factor, a blank tool which provides the player with a blank tile which is used as a replacement of any alphabet to form a word, a scramble tool that scrambles any unused bonus squares for a turn of the player and then returns back to the original position assigned at the start of the game, a blocking square tool that allows the player to place a blocking square on the game board in order to block the opponent from accessing their alphabets, a letter tracker tool that allows a player to view inventory of alphabets for all the players within the game themselves and the opponents and the like.

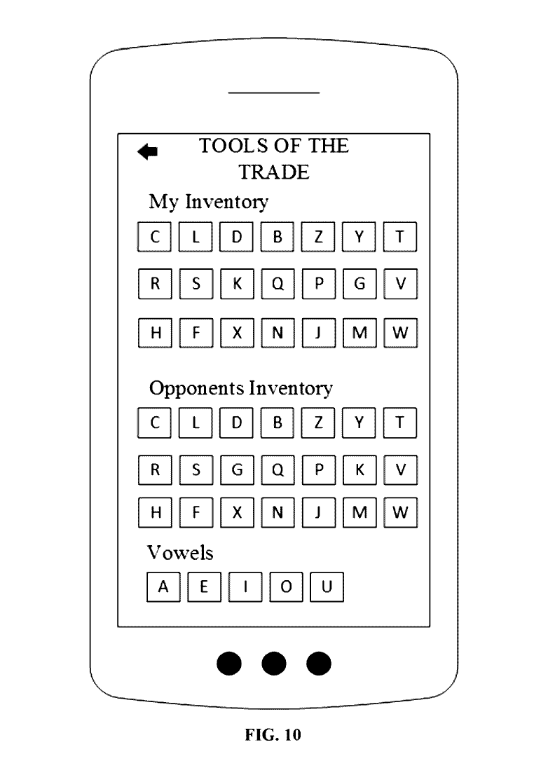

FIG. 10 illustrates a screen shot of the software application screen exhibiting the strategic tool letter tracker, according to one embodiment herein. With respect to FIG. 10, on selecting the letter tracker tool option from the tool bar, the player is allowed to view the inventory of alphabets for themselves and the opponents. The inventory also depicts the count of each of the alphabets remaining in the inventory and additionally offers option to view the list of vowels from the common pool available for forming the word.

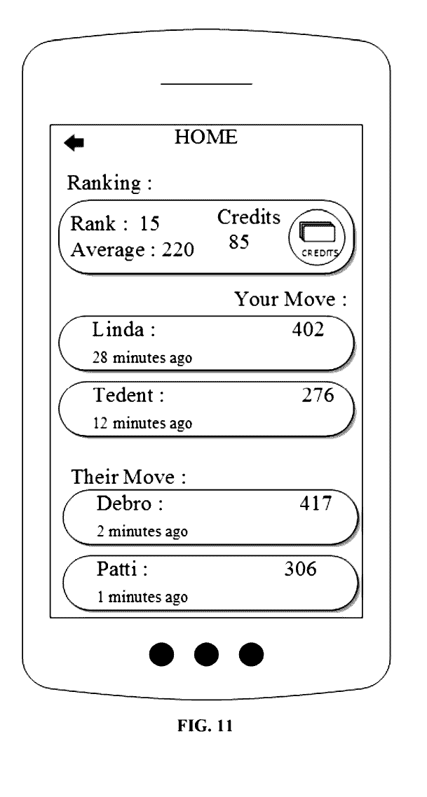

FIG. 11 illustrates a screen shot of the software application screen displaying a home page of the software application, according to one embodiment herein. With respect to FIG. 11, the home page for the software application is provided. The home page displays the rank of the player, average score calculated using the historical score, credit account details and the list of opponents and their respective score along with the timing details when the last move is made by the opponents.

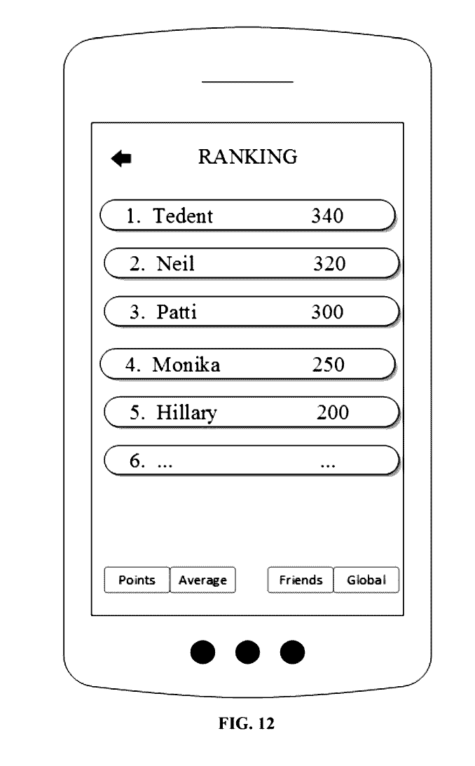

FIG. 12 illustrates a screen shot of the software application screen disclosing a ranking of the player against other set of players, according to one embodiment herein. With respect to FIG. 12, the ranking of the player with respect to other opponents is displayed. The player has an option to compare the ranking based on multiple criteria such as ranking against friends, global ranking, ranking based on points, ranking based on average of historical score and the like.

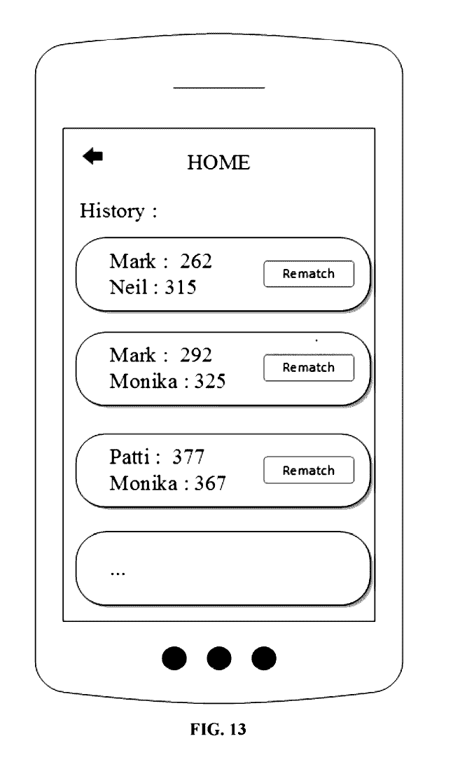

FIG. 13 illustrates a screen shot of the software application screen exhibiting a historical data related to the word games previously played by the player, according to one embodiment herein. The player is presented with the list of previously played games along with the details of opponents and the scores of the game. Additionally it offers the option to retrigger a new match among the set of players participated in the previous game.

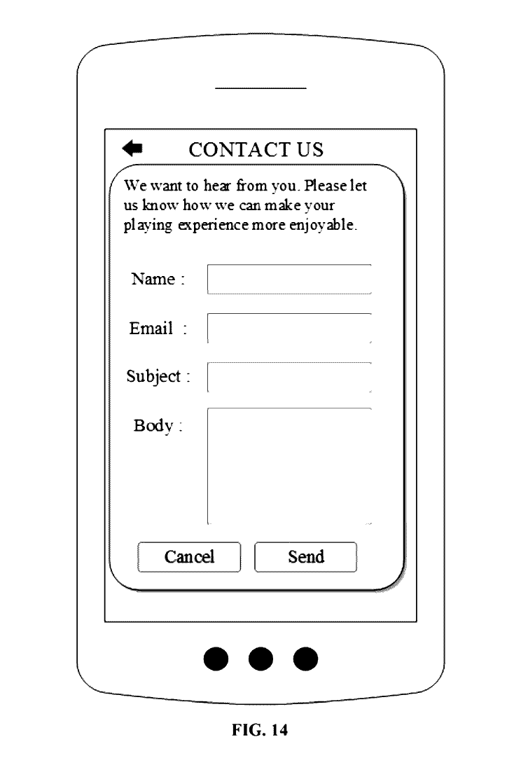

FIG. 14 illustrates a screen shot of the software application screen displaying a feedback form to be filled in by the player to provide feedback about the game, according to one embodiment herein. The form can be filled by any of the registered user to provide a feedback about the word game, to propose new features, to report any issues faced while playing the word game with the providers of the game. The inputs provided by the players are used to enhance the features of the game and to resolve any identified issue.

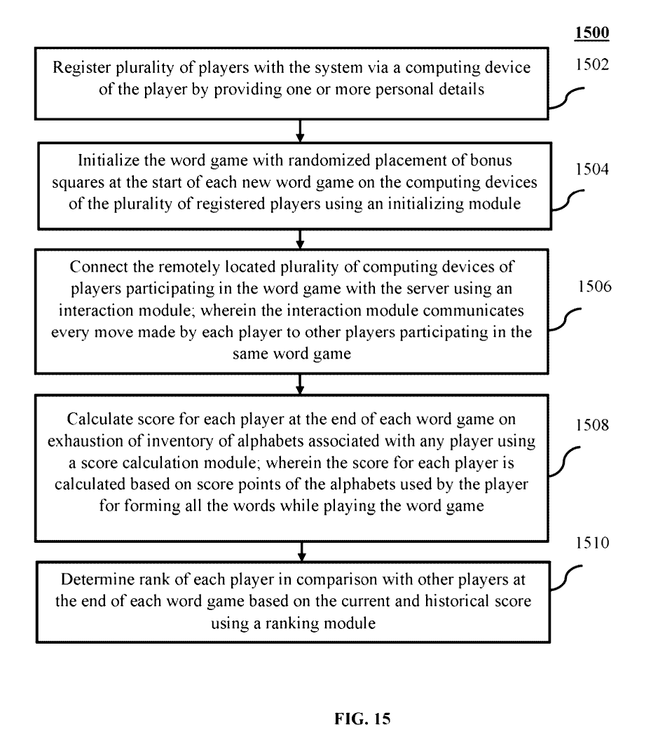

FIG. 15 illustrates a flow chart explaining a method for managing word games, according to one embodiment herein. The method comprises the steps of registering plurality of players with the system via a computing device 102 of the player by providing one or more personal details (1502). The computing device 102 of the player is configured for hosting a software application to interact with a server provided in the system. The software application is configured for presenting a grid layout to the player for playing the word game. The grid layout comprises plurality of squares for placing one or more alphabets to form a word. The grid layout further comprises one or more bonus squares offering additional features. The word game with randomized placement of bonus squares is initialized at the start of each new word game on the computing devices 102 of the plurality of registered players using an initializing module 110 (1504). The initialization module 110 is configured for assigning each player with an inventory of same set of alphabets and randomly placing one or more bonus squares on the grid layout at the start of each new word game. The remotely located plurality of computing devices 102 of players participating in the word game are connected with the server using an interaction module 112 (1506). The interaction module 112 communicates every move made by each player to other players participating in the same word game. Score for each player is calculated at the end of each word game on exhaustion of inventory of alphabets associated with any player using a score calculation module 114 (1508). The score for each player is calculated based on score points of the alphabets used by the player for forming all the words while playing the word game. Rank of each player is determined in comparison with other players at the end of each word game based on the current and historical score using a ranking module 118 (1510).

Therefore, the system and method of the proposed invention provides an electronic board game offering several advantages as compared to traditional physical board games. The system and method enhances the gaming experience by offering a different game board to the players by randomizing all the bonus squares from the grid layout prior to starting each new word game. The system and method also offers the convenience of playing the game with any other remotely located players without being physically present together. Thus, global tournaments are convenient to organize without involving the financial expenditures related to travel costs.

The embodiments herein enhance the social interaction experience of the players while playing the word game as compared to playing computer or electronic games usually designed for a single player to interact with a machine. Often a collaborative/competitive multi-player board game experience is more desired by the players than the isolation typically associated with a computer/electronic game. Further, each player worldwide always starts with the exact same supply of alphabets in both count and value. Thus, the outcome of the word game is decided by how well a player uses their alphabets and not by the luck of drawing the higher value alphabets.

Some other advantages provided by the proposed invention include compact game board for playing and storing the game related information, ability to load multiple games on the same game board, no loose game-pieces to be lost, easy on-demand access to stored information regarding game rules, real-time game status updates, etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A word game management system, the system comprising:
a computing device of a player configured for hosting a software application to interact with a server provided in the system, and wherein the software application is configured for presenting a grid layout to the player for playing the word game, and wherein the grid layout comprises a plurality of squares for placing one or more alphabets to form a word, and wherein the grid layout further comprises one or more bonus squares offering additional features;
a registration module provided in the server, and wherein the registration module is run on a hardware processor and configured for registering the plurality of players with the system by providing one or more personal details;
an initialization module provided in a server, and wherein the initialization module is run on a hardware processor and configured for initializing the word game on the computing devices of the plurality of registered players, and wherein the initialization module is configured for assigning each player with an inventory of same set of alphabets and randomly placing one or more bonus squares on the grid layout at the start of each new word game, and wherein each alphabet in the inventory is assigned with a predefined or fixed score point;
an interaction module provided in a server and wherein the interaction module is run on a hardware processor and configured for connecting the plurality of computing devices of remotely located players participating in the word game with the server, and wherein the interaction module is configured to communicate every move made by each player to other players or rest of the players participating in the same word game;
a score calculation module provided in a server, and wherein the score calculation module is run on a hardware processor and configured for calculating score for each player at the end of each word game on exhaustion of inventory of alphabets associated with any player, and wherein the score for each player is calculated based on score points of the alphabets used by the player for forming all the words while playing the word game; and
a ranking module provided in a server, and wherein the ranking module is run on a hardware processor and configured for calculating a rank of each player in comparison with other players at the end of each word game based on the current and historical score.

2. The system according to claim 1, wherein the initialization module is further configured for creating a credit account for each player registered with the system for maintaining credit points associated with each player, and wherein each player is assigned with a predefined number of credit points on registering with the system.

3. The system according to claim 1 further comprises a database configured for storing individual score associated with each player for each word game, and wherein the database is further configured for storing historical score associated with each player for previously played word games and credit account details associated with each player.

4. The system according to claim 1, wherein the system is further configured for providing each player with one or more strategic tools for use during each word game on deduction of predefined number of credit points, and wherein the one or more strategic tools are configured for helping the player to strategize the play against the opponent or for increasing the chances of winning the word game by increasing the player's game score.

5. The system according to claim 4, wherein the one or more strategic tools comprise a boost tool, a blank tool, a scramble tool, a blocking square tool, and a letter tracker tool, and wherein the boost tool is configured for increasing the value of a bonus square by a predefined factor, and wherein the blank tool is configured to provide the player with a blank tile for replacing any alphabet to form a word, and wherein the scramble tool is configured to scramble any unused bonus squares for a turn of the player and then returns back to the original position assigned at the start of the game, and wherein the blocking square tool is configured to allow the player to place a blocking square on the game board to block the opponent player or rest of the players from accessing their alphabets, and wherein the letter tracker tool is configured to allow a player to view an inventory of alphabets for all the players within the game themselves and the opponents or the rest of the participating players in the same game.

6. The system according to claim 1, further comprises a credit estimation module configured for assigning or deducting credit points to/from each players credit account based on one or more criteria, and wherein the one or more criteria for assigning or deducting the credit points comprise a winning/losing a word game, selecting a new game for playing, winning different levels of a tournament, use of one or more strategic tools during the play, and purchased credit points.

7. The system according to claim 1, further comprises a notification module configured for generating one or more notifications for notifying the players regarding the proceedings of the word game.

8. The system according to claim 7, wherein the one or more notifications generated with the notification module comprise notifications regarding a status of opponent's inventory, status of the word game, opponents pending turn, and players own turn.

9. The system according to claim 1, wherein the additional features provided by bonus squares comprise one or more double and triple letter square leading to addition of double and triple scores/points for the alphabet placed on the square to the players score respectively, one or more double and triple word square leading to addition of double and triple scores/points for the whole word formed to the players score respectively, and one or more ‘Go’ square that provides the player additional turn and one or more blocking square to block a placement of any alphabet during the play.

10. The system according to claim 1, wherein the plurality of players are provided with a predefined number of chances before losing their turn to form a word.

11. The system according to claim 1, wherein the initialization module is further configured for randomly filling in the used alphabets for each player's turn in order to maintain a predefined number of consonants and vowels for forming each word.

12. The system according to claim 1, wherein the software application is further configured for timely updating the plurality of players regarding future events and tournaments open for participation.

13. The system according to claim 1, further configured for providing the plurality of players with an option to play the word game on a single computing device by being physically present at a same location as that of the computing device.

14. The system according to claim 1, further configured for providing each player with an option to play one or more word game simultaneously with remotely located players via the computing device.

15. A computer implemented method comprising instructions stored on a non-transitory computer readable storage medium and run a computing device provided with a hardware processor and memory for managing word games, the method comprising the steps of:
registering plurality of players with the system via a computing device of the player by providing one or more personal details, and wherein the computing device of the player is configured for hosting a software application to interact with a server provided in the system, and wherein the software application is configured for presenting a grid layout to the player for playing the word game, and wherein the grid layout comprises a plurality of squares for placing one or more alphabets to form a word, and wherein the grid layout further comprises one or more bonus squares offering additional features;
initializing the word game with randomized placement of bonus squares at the start of each new word game on the computing devices of the plurality of registered players using an initializing module, and wherein the initialization module is configured for assigning each player with an inventory of same set of alphabets;
connecting the remotely located plurality of computing devices of players participating in the word game with the server using an interaction module, and wherein the interaction module is configured to communicate every move made by each player to other players participating in the same word game;
calculating score for each player at the end of each word game on exhaustion of inventory of alphabets associated with any player using a score calculation module, and wherein the score for each player is calculated based on score points of the alphabets used by the player for forming all the words while playing the word game; and
determining rank of each player in comparison with other players at the end of each word game based on the current and historical score using a ranking module.

16. The method according to claim 15, wherein a plurality of credit points are assigned or deducted for each player based on one or more criteria using a credit calculation module, and wherein the one or more criteria for assigning or deducting the credit points comprise winning/losing a word game, selecting a new game for playing, winning different levels of a tournament, use of one or more strategic tools during the play, and purchased credit points.

17. The method according to claim 15, wherein the method further comprises providing each player with one or more strategic tools for use during each word game on deduction of predefined number of credit points, and wherein the one or more strategic tools are configured for helping the player to strategize the play against the opponent or for earning additional credit points.

18. The method according to claim 15, wherein the additional features provided by bonus squares comprise one or more double and triple letter square for adding double and triple scores/points for the alphabet placed on the square to the players score respectively, one or more double and triple word square for adding double and triple scores/points for the whole word formed to the players score respectively, and one or more ‘Go’ square that allows the player to provide additional turn and one or more blocking square to prevent a placement of any alphabet during the play.
